(19) United States
(12) Patent Application Publication
(10) Pub. No.: US 2024/0062461 A1
(43) Pub. Date: Feb. 22, 2024

(54) METHOD AND SYSTEM FOR PRODUCING A DIGITAL TERRAIN MODEL

(71) Applicant: First Resource Management Group Inc., North Bay (CA)

(72) Inventors: Benoit St-Onge, Montreal, Quebec (CA); Philip E.J. Green, Mississauga, Ontario (CA)

(21) Appl. No.: 18/270,577

(22) PCT Filed: Dec. 30, 2021
(86) PCT No.: PCT/CA2021/000108

§ 371 Date: Jun. 30, 2023

(30) Foreign Application Priority Data
Dec. 30, 2020 (CA) 3104464

(51) Int. Cl. G06T 17/05; G06V 20/17; G06V 20/13; G01C 11/04

(52) U.S. Cl. CPC G06T 17/05; G06V 20/17; G06V 20/13; G01C 11/04; G06V 20/188

(57) ABSTRACT

A method and system for calculating a digital terrain model (DIM) for a target portion of the surface of the Earth. A digital elevation model (DEM) for the target portion specifies an elevation for target points on the Earth within the portion. A digital surface model (DSM) specifies the elevation above the target point of an obstructing surface. Elevation errors in the DEM are corrected. A curvature correction is done using the DSM. A model is calibrated using reference points using statistical techniques or machine learning. A model using reference points for predicting the amount of local elevation correction needed at each target point as a function of terrain curvature is employed. The models are applied at each target point of the DEM to produce the DTM.

### FIELD OF THE INVENTION

The present invention relates to digital terrain models of the Earth's surface.

### BACKGROUND OF THE INVENTION

Forest management is a branch of forestry concerned with forest regulation including silviculture, management for aesthetics, fish, recreation, urban values, water, wilderness, wildlife, wood products, forest genetic resources, and other forest resource values. Forest management techniques include timber extraction, planting and replanting of various species, cutting roads and pathways through forests, and preventing fire.

The planning of harvesting, renewal and tending activities requires accurate information about the terrain, such as absolute elevation and local terrain slope, which determine drainage of water and operability of silvicultural machinery. Detailed information about the terrain is particularly useful for forest-product companies and government agencies for such purposes as mapping probable locations of streams, for determining the placement of roads, and for determining the path of timber harvesting equipment during operations.

Known systems, configured to estimate forest inventory, provide hardwood and softwood inventory calculations (estimates) by using LiDAR images in a process for estimating forest inventory. LiDAR is a remote sensing technology that measures distance by illuminating a target with a laser and analyzing the reflected light. LiDAR is an acronym for Light Detection And Ranging (also known as airborne laser altimetry, or airborne scanning laser). LiDAR systems are used to make high-resolution three-dimensional maps, with applications in forestry management, geomatics, archaeology, geography, geology, geomorphology, seismology, remote sensing, atmospheric physics, and contour mapping. While LiDAR imaging techniques, depending on the embodiment, may produce more accurate hardwood and softwood volume calculations than by using conventional aerial photographic imaging, and may produce more detailed terrain information than conventional topographic mapping, LiDAR may be prohibitively expensive, and, as well, LiDAR data may not be readily available for more remote geographic areas. Because forest inventories need to be updated regularly (e.g. every five years), it is impractical to use LIDAR for this purpose.

Known systems, configured to estimate terrain, provide digital terrain models (DTMs), are intended to represent the bare earth elevation of the terrain, even under forest canopies. Conventional methods rely on photo-interpretation of aerial photographs to draw elevation contour lines. These are both inaccurate, and spatially imprecise. Because photo-interpreters often do not see the bare terrain under forest canopies, they can only approximate its true elevation. Errors as high as 10 m are not uncommon. Moreover, contour lines only describe the elevation at the contour location, so they can be said to have a low resolution. The rest of the elevation information must be deduced by interpolation, with highly uncertain outcomes.

Known systems, configured to estimate terrain, provide digital terrain models, are intended to represent the bare earth elevation of the terrain, even under forest canopies. LiDAR offers both high accuracy and high spatial precision. The accuracy of LiDAR digital terrain models under forest canopies is 30 cm or better. The density of LiDAR returns having hit the ground allows for the creation of digital terrain models with a high resolution (e.g. 1 m pixel size). However, for such accuracy and precision levels to be achieved, the LiDAR sensors have to be flown at low altitude (typically below 2000 meters). This entails a large number of flight lines for a given territory, and hence, large costs. What is more, the LiDAR returns need to be classified into “ground” and “not-ground” categories. Part of this classification is done manually by technicians, and represents a significant portion (e.g. 20%) of the data production costs.

There is a need to produce accurate DTMs that do not require LiDAR data.

### SUMMARY OF THE INVENTION

At a high level, the invention calculates a digital terrain model (DTM) for a target portion of the surface of the Earth based on a digital elevation model (DEM) for the target portion.

The first step is to receive or obtain a DEM for the target portion, the DEM specifying an approximate elevation for a number of target points on the Earth within the portion. A digital surface model (DSM) is also received or obtained. The DSM is produced using a spaceborne or airborne vehicle, specifying, for each of the target points, the elevation above the target point of an obstructing surface visible from the spaceborne or airborne vehicle when the vehicle is in flight above the target point or, where there is no obstructing surface above the target point, the elevation of the target point.

Then, elevation errors in the DEM caused by land cover, including vegetation obstructing the view of the target points, and by terrain curvature are corrected. The land cover correction is done using imagery and related ancillary data, the imagery and ancillary data being acquired at a period of time roughly corresponding to the time of the acquisition of DEM data. The imagery is radiometrically corrected for the effects of topography on image brightness. The curvature correction is done using the DSM.

A model is calibrated using reference points, each reference point having accurate values of latitude, longitude and elevation, using statistical techniques or machine learning, for predicting the amount of local elevation correction needed at each target point as a function of land cover.

A model is also calibrated using reference points, each reference point having accurate values of latitude, longitude and elevation, using statistical techniques or machine learning, for predicting the amount of local elevation correction needed at each target point as a function of terrain curvature.

The models are applied at each target point of the DEM to produce the DTM.

The method may further include receiving data and imagery of the target portion collected by a spaceborne or airborne vehicle using optical and/or infrared sensors, and computing the DSM using the received data and imagery. The DSM may be computed using known methods.

The method may further include receiving synthetic aperture radar data of the target portion, and using the data to produce the DEM. The DEM may be computed using known methods.
data and imagery of the target portion collected by a spaceborne or airborne vehicle using radar, optical and/or infrared sensors, and computing the DSM using the received data and imagery. The DSM may be computed using known methods.
data and imagery of the target portion collected by a spaceborne or airborne vehicle using radar, optical and/or infrared sensors, and computing the DEM using the received data and imagery. The DEM may be computed using known methods.

The invention also provides a system including one or more computer processors configured to perform the above methods.

The invention also provides a system to receive, via the interface, data and imagery of a target portion of the surface of the Earth collected by a spaceborne or airborne vehicle, compute a digital surface model (DSM) for the target portion using the received data and imagery, and perform the above methods. The data and imagery may be collected using optical and/or infrared sensors.

The invention also provides a system to receive, via the interface, data and imagery of a target portion of the surface of the Earth collected by a spaceborne or airborne vehicle, compute a digital elevation model (DEM) for the target portion using the received data and imagery, and perform the above methods. The data and imagery may be collected using optical and/or infrared sensors.

### BRIEF DESCRIPTION OF THE DRAWINGS

FIG. 1 is a horizontal cross-section of a portion of the surface of the Earth showing aspects of a DTM, DSM and CHM.

FIG. 2 provides an example of a DTM computed by the methods described herein as shown in the solid line, compared with more expensive prior art methods as shown in the dashed lines.

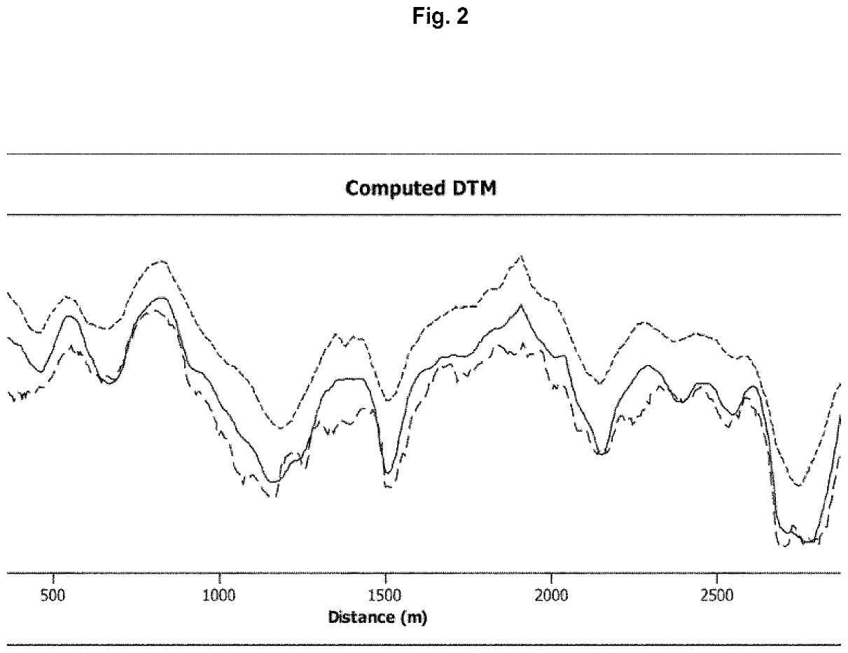

### DETAILED DESCRIPTION OF THE INVENTION

As used herein, a digital elevation model (DEM) is a raster (pixel array) digital representation of the approximate elevations of the Earth's topography. DEM is a generic term used to designate an elevation model that does not exactly represent bare-earth terrain elevation (ground level, even below forest canopies), nor surface elevations (of any surfaces visible from the air or space, e.g., the surface of a vegetation canopy, rooftops, etc.). In the presence of a vegetation canopy, a DEM sits somewhere between the ground and another higher surface (e.g., somewhere between the ground and the surface of a vegetation canopy, when the latter is present).

As used herein, a digital terrain model (DTM) is a raster (pixel array) digital representation of the elevations of the bare-earth ground level, whether the ground is visible from the air or space, or whether it is covered by vegetation or other objects.

As used herein, a digital surface model (DSM) is a raster (pixel array) digital representation of the elevations of all surfaces directly visible from the air or space (exposed bare ground, vegetation surfaces, rooftops, etc.).

As used herein, a canopy height model (CHM) is a raster (pixel array) digital representation of the height of forest and other vegetation canopies (height of the surface of canopies above ground, i.e., the elevation difference between the DSM and the DTM).

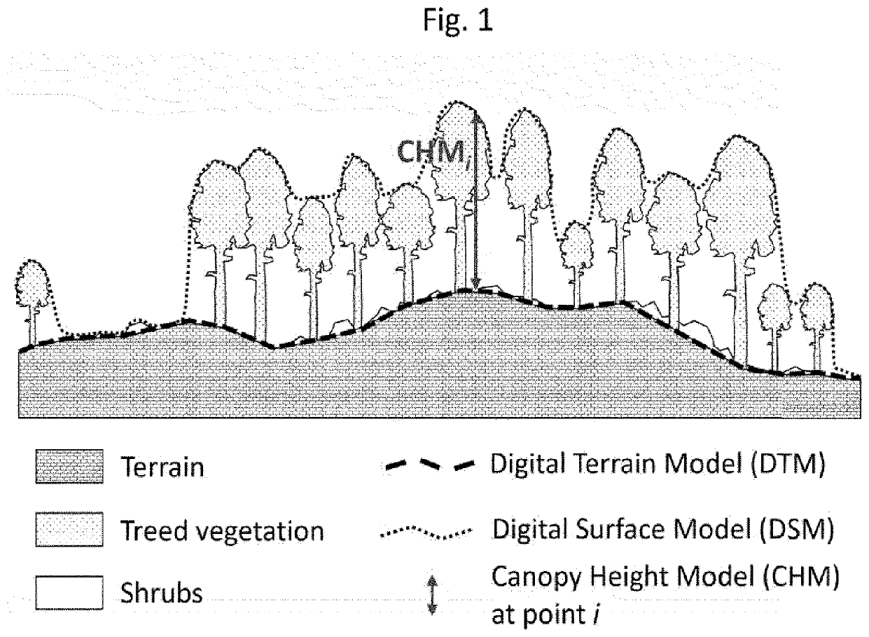

FIG. 1 depicts examples of the information provided by each of a DTM, DSM and CHM.

The system/method calculates a digital terrain model (DTM) for a target portion (or region) of the surface of the Earth based on a DEM and DSM for the target portion.

The DEM for the target portion, specifies an approximate elevation for a number of target points on the Earth within the target portion. The target points are generally regularly spaced within the target region. The DEM may be produced, for example, by an interferometric synthetic aperture radar system, or by a combination of image matching and photogrammetry. The system/method may also include the production of the DEM using synthetic aperture radar data of the target portion. Methods to produce such a DEM are known.

The method employs a DSM for the target portion, produced using a spaceborne or airborne vehicle, specifying, for each of the target points, the elevation above the target point of an obstructing surface visible from the spaceborne or airborne vehicle when the vehicle is in flight above the target point or, where there is no obstructing surface above the target point, the elevation of the target point. The DSM may be produced, for example, by an interferometric synthetic aperture radar system, or by a combination of image matching and photogrammetry. The system/method may also include the production of the DSM. Methods to produce such a DSM are known.

The method corrects elevation errors in the DEM caused by land cover, including vegetation obstructing the view of the target points, and by terrain curvature. The land cover correction is done using imagery and related ancillary data, the imagery and ancillary data being acquired at a period of time roughly corresponding to the time of the acquisition of DEM data. The imagery is radiometrically corrected for the effects of topography on image brightness. The imagery may be, for example, optical or radar imagery. The curvature calculation is done using the DSM.

Reference points are acquired. Each reference point has accurate values of latitude, longitude and elevation.

A model is calibrated with the reference points, using statistical techniques or machine learning, to predict the amount of local elevation correction needed at each target point as a function of land cover.

A model is calibrated with the reference points, using statistical techniques or machine learning, to predict the amount of local elevation correction needed at each target point as a function of terrain curvature.

The models are applied at each target point of the DEM to produce the DTM, effectively turning the DEM into a DTM. Each target point defines a spatial cell in the target portion. Generally, the collection of target points and their cells cover the entire target portion.

The land cover correction is is preferably done by extracting at each target point the land cover characteristics from the imagery and ancillary data. Then the amount of local elevation correction as a function of land cover using the land cover model is predicted for each target point, and the elevation of the target point elevations are corrected accordingly.

The curvature correction is preferably done by calculating at each target point the local terrain curvature of the DSM, predicting the amount of local elevation correction as a function of terrain curvature using the terrain curvature model, and correcting the elevation of the target point elevation accordingly.

The land cover model is preferably calculated by receiving imagery and ancillary data, correcting the imagery for the radiometric effects of topography and sun position in the case of optical imagery, or topography and the view angle in the case of radar images. The corrected image values at the latitude and longitude of the reference points are extracted, calculating the difference between the elevation of reference points and the corresponding elevation of the DEM at the latitudes and longitudes or the reference points, and establishing a relationship between the image values and the corresponding elevation differences by calibrating a statistical or machine learning model.

The terrain curvature model is calculated by calculating the local terrain curvature at every point of the DSM. The terrain curvature values at the latitude and longitude of the reference points are extracted, calculating the difference between the elevation of reference points and the corresponding elevation of the DEM at the latitudes and longitudes or the reference points. The relationship between the terrain curvature values and the corresponding elevation differences is established by calibrating a statistical or machine learning model.

The imagery and ancillary data are preferably acquired at a period of time within 7 years of the time of the acquisition of DEM data. In some embodiments, the period of time may be 2, 3, 4, 5, 6, 8, 9, 10 or 15 years.

The reference points are preferably geodetic survey points, global navigation satellite system (GNSS) points, airborne light detection and ranging (LIDAR) points, or spaceborne LIDAR points.

The accurate values of the latitude and longitude of the reference points are preferably accurate to within 10 m and the accurate values of the elevations of the reference points are preferably accurate to within 1 m. In some embodiments, the latitude and longitude of the reference points may be accurate to within 5, 6, 7, 8, 9, 11, 12 13, 14 or 15 meters. In some embodiments, the elevations of the reference points may be accurate to within 0.5, 0.6, 0.7, 0.8, 0.9, 1.1, 1.2, 1.3, 1.4 or 1.5 meters.

The ancillary data may include, but is not limited to, date, sun position, and view angle corresponding to the imagery.

The approximate elevation for each of the target points of the DEM is preferably accurate to within 20 m. In some embodiments, the approximate elevation for each of the target points may be accurate to within 5, 6, 8, 10, 12, 14, 16, 18, 20, 22, 24, 26, 28, 32, 34, 36, 38 or 40 meters.

The invention also provides a system that performs the above-described method. The system includes a computer processor and memory.

Generally, a computer, computer system, computing device, client or server, as will be well understood by a person skilled in the art, includes one or more than one electronic computer processor, and may include separate memory, and one or more input and/or output (1/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

The abbreviation “m” as used herein refers to metres (or in the US, “meters”).

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

1. A method performed by a computer processor for calculating a digital terrain model (DTM) for a target portion of the surface of the Earth, the method comprising:
receiving a digital elevation model (DEM) for the target portion, the DEM specifying an approximate elevation for each of a plurality of target points on the Earth within the portion;
receiving a digital surface model (DSM), produced using a spaceborne or airborne vehicle that has imaged the target portion, specifying, for each of the target points, the elevation above the target point of an obstructing surface visible from the spaceborne or airborne vehicle when the vehicle is in flight above the target point or, where there is no obstructing surface above the target point, the elevation of the target point;
correcting elevation errors in the DEM caused by land cover, including vegetation obstructing the view of the target points, and by terrain curvature, wherein the land cover correction is done using imagery and related ancillary data, the imagery and ancillary data being acquired at a period of time roughly corresponding to the time of the acquisition of DEM data, the imagery being radiometrically corrected for the effects of topography on image brightness, wherein the curvature correction is done using the DSM;
calibrating a model using reference points, each reference point having accurate values of latitude, longitude and elevation, using statistical techniques or machine learning, for predicting the amount of local elevation correction needed at each target point as a function of land cover;
calibrating a model using reference points, each reference point having accurate values of latitude, longitude and elevation, using statistical techniques or machine learning, for predicting the amount of local elevation correction needed at each target point as a function of terrain curvature;
applying the models at each target point of the DEM to produce the DTM.

2. The method of claim 1, wherein the land cover correction is done by extracting at each target point the land cover characteristics from the imagery and ancillary data, predicting the amount of local elevation correction as a function of land cover using the land cover model, and correcting the elevation of the target point elevation accordingly.

3. The method of claim 1, wherein the curvature correction is done by calculating at each target point the local terrain curvature of the DSM, predicting the amount of local elevation correction as a function of terrain curvature using the terrain curvature model, and correcting the elevation of the target point elevation accordingly.

4. The method of claim 1, wherein calculation of the land cover model is done by receiving imagery and ancillary data collected by a spaceborne or airborne vehicle of the target portion, correcting the imagery for the radiometric effects of topography and sun position in the case of optical imagery, or topography and the view angle in the case of radar images, extracting the corrected image values at the latitude and longitude of the reference points, calculating the difference between the elevation of reference points and the corresponding elevation of the DEM at the latitudes and longitudes or the reference points, and establishing a relationship between the image values and the corresponding elevation differences by calibrating a statistical or machine learning model.

5. The method of claim 1, wherein calculation of the terrain curvature model is done by calculating the local terrain curvature at every point of the DSM, extracting the terrain curvature values at the latitude and longitude of the reference points, calculating the difference between the elevation of reference points and the corresponding elevation of the DEM at the latitudes and longitudes or the reference points, and establishing a relationship between the terrain curvature values and the corresponding elevation differences by calibrating a statistical or machine learning model.

6. The method of claim 1, wherein the imagery and ancillary data are acquired at a period of time within 7 years of the acquisition of DEM data.

7. The method of claim 1, wherein the reference points are geodetic survey points, global navigation satellite system (GNSS) points, airborne light detection and ranging (LIDAR) points, or spaceborne LIDAR points.

8. The method of claim 1, wherein the accurate values of the latitude and longitude of the reference points are accurate to within 10 m and the accurate values of the elevations of the reference points are accurate to within 1 m.

9. The method of claim 1, wherein the DEM is produced using data collected by an interferometric synthetic aperture radar system.

10. The method of claim 1, wherein the DEM is produced using a combination of image matching and photogrammetry.

11. The method of claim 1, wherein the DSM is produced using data collected by an interferometric synthetic aperture radar system.

12. The method of claim 1, wherein the DSM is produced using a combination of image matching and photogrammetry.

13. The method of claim 1, wherein the imagery is optical imagery.

14. The method of claim 1, wherein the imagery is radar imagery.

15. The method of claim 1, wherein the ancillary data includes date, sun position, and view angle corresponding to the imagery.

16. The method of claim 1, wherein the approximate elevation for each of the plurality of target points is accurate to within 30 m.

17. The method of claim 1, further comprising receiving, via an electronic interface, data and imagery of the target portion of the surface of the Earth collected by a spaceborne or airborne vehicle, and (b) computing the DSM for the target portion using the received data and imagery.

18. The method of claim 1, further comprising receiving, via an electronic interface, data and imagery of the target portion of the surface of the Earth collected by a spaceborne or airborne vehicle, and (b) computing the DEM for the target portion using the received data and imagery.

19. A system comprising one or more processors and a digital memory in electronic communication with the one or more processors, wherein the one or more processors are configured to perform the method of claim 1.

20. A system comprising one or more processors, a digital memory in electronic communication with the one or more processors, a data interface, wherein the one or more processors are further configured to (a) receive, via the interface, data and imagery of a target portion of the surface of the Earth collected by a spaceborne or airborne vehicle, (b) compute a digital surface model (DSM) for the target portion using the received data and imagery, and (c) perform the method of claim 1.

21. The system of claim 20, wherein the one or more processors are further configured to (a) receive, via the interface, data and imagery of a target portion of the surface of the Earth collected by a spaceborne or airborne vehicle, and (b) compute a digital elevation model (DEM) for the target portion using the received data and imagery.
